(19) United States
(12) Patent Application Publication
(10) Pub. No.: US 2023/0415642 A1
(43) Pub. Date: Dec. 28, 2023

(54) GETTING-OFF SUPPORT APPARATUS, GETTING-OFF SUPPORT METHOD, AND COMPUTER-READABLE MEDIUM

(71) Applicant: JVCKENWOOD Corporation, Yokohama-shi (JP)

(72) Inventor: Masao UBUKATA, Yokohama-shi (JP)

(21) Appl. No.: 18/243,816

(22) Filed: Sep. 8, 2023

Related U.S. Application Data
(63) Continuation of application No. PCT/JP2021/035352, filed on Sep. 27, 2021.

(30) Foreign Application Priority Data
Mar. 9, 2021 (JP) 2021-036965
Mar. 9, 2021 (JP) 2021-036966

(51) Int. Cl. B60Q 1/50; B60Q 3/70; G06V 20/56

(52) U.S. Cl. CPC B60Q 1/544; B60Q 3/70; G06V 20/56

(57) ABSTRACT

In a getting-off support apparatus, a measurement unit measures an approaching direction and moving velocity of a mobile object, and a distance between the own vehicle and the mobile object. A getting-off operation detection unit detects getting-off operation of a passenger in the own vehicle. A control unit controls output of a notification signal in accordance with the distance and the moving velocity of the mobile object. A notification signal output unit outputs a second notification signal to the passenger. The control unit estimates a period until when the mobile object reaches the own vehicle when the getting-off operation is detected, and outputs a second notification signal in a case where for the mobile object for which the estimated period is equal to or greater than a threshold, the distance is less than a limit distance, and the moving velocity is equal to or greater than limit velocity.

### CROSS REFERENCE TO RELATED APPLICATION

The present application is a bypass continuation of International Patent Application PCT/JP2021/035352, filed on Sep. 27, 2021, which is based upon and claims the benefit of priority from Japanese Patent Application No. 2021-036965, filed on Mar. 9, 2021, Japanese Patent Application No. 2021-036966, filed on Mar. 9, 2021, the disclosure of both of which are incorporated herein in its entirety by reference.

### BACKGROUND

The present invention relates to a getting-off support apparatus, a getting-off support method, and a program.

A getting-off support apparatus for securing safety when a person inside a vehicle gets out of the vehicle after the vehicle is stopped has been proposed.

For example, a disembarkation support apparatus disclosed in Japanese Unexamined Patent Application Publication No. 2020-093567 gives an alarm or executes limitation on opening of doors in a case where an object approaching the own vehicle is detected when disembarkation operation by a passenger of the own vehicle is detected. This disembarkation support apparatus uses an electronic outer mirror when a shielding material exists when the own vehicle is parked or stopped and uses a rear-side radar when a shielding material does not exist.

Further, this disembarkation support apparatus executes disembarkation limitation operation that is operation including alarming operation of giving an alarm for doors of the own vehicle and opening door limitation operation of limiting opening of doors.

### SUMMARY

However, while the above-described technique performs operation of giving an alarm or limiting opening of doors in a case where a mobile object that is approaching the own vehicle is detected, there are various states of the mobile object and circumstances of the own vehicle.

The present embodiment has been made to solve the above-described problem and is directed to providing a getting-off support apparatus that performs preferred getting-off support, a getting-off support method, and a program.

A getting-off support apparatus according to the present disclosure includes a measurement unit, a getting-off operation detection unit, a notification signal output unit and a control unit. The measurement unit measures an approaching direction of a mobile object that is approaching an own vehicle, and a distance between the own vehicle and the mobile object. The getting-off operation detection unit detects getting-off operation of a passenger in the own vehicle. The notification signal output unit outputs a notification signal for notifying at least one of the mobile object or the passenger of approach between the own vehicle and the mobile object. The control unit controls output of the notification signal in accordance with the distance to the mobile object in a case where the getting-off operation is detected.

A getting-off support method according to the present disclosure includes a measurement step, a getting-off operation detection step, a notification signal output step and a control step. In the measurement step, an approaching direction of a mobile object that is approaching an own vehicle, and a distance between the own vehicle and the mobile object are measured. In the getting-off operation detection step, getting-off operation of a passenger in the own vehicle is detected. In the notification signal output step, a notification signal is output for notifying at least one of the mobile object or the passenger of approach between the own vehicle and the mobile object. The control step controls, in a case where the getting-off operation is detected, output of the notification signal in accordance with the distance to the mobile object.

A program according to the present disclosure causes a computer to execute a getting-off support method. The getting-off support method includes a measurement step, a getting-off operation detection step, a notification signal output step and a control step. In the measurement step, an approaching direction of a mobile object that is approaching the own vehicle, and a distance between the own vehicle and the mobile object are measured. In the getting-off operation detection step, getting-off operation of a passenger in the own vehicle is detected. In the notification signal output step, a notification signal is output for notifying at least one of the mobile object or the passenger of approach between the own vehicle and the mobile object. The control step controls, in a case where the getting-off operation is detected, output of the notification signal in accordance with the distance to the mobile object.

According to the present disclosure, it is possible to provide a getting-off support apparatus that performs preferred getting-off support, a getting-off support method and a program.

### BRIEF DESCRIPTION OF THE DRAWINGS

FIG. 1 is a view illustrating a vehicle according to an embodiment.

FIG. 2 is a block diagram of a getting-off support apparatus according to a first embodiment.

FIG. 3 is a flowchart of the getting-off support apparatus according to the first embodiment.

FIG. 4 is a view illustrating an example of circumstances where the getting-off support apparatus according to the first embodiment operates.

FIG. 5 is a block diagram of a getting-off support apparatus according to a second embodiment.

FIG. 6 is a flowchart of the getting-off support apparatus according to the second embodiment.

FIG. 7 is a view illustrating an example of circumstances where the getting-off support apparatus according to the second embodiment operates.

FIG. 8 is a block diagram of a getting-off support apparatus according to a third embodiment.

FIG. 9 is a flowchart of the getting-off support apparatus according to the third embodiment.

FIG. 10 is a flowchart of a getting-off support apparatus according to a fourth embodiment.

FIG. 11 is a view illustrating an example of circumstances where the getting-off support apparatus according to the fourth embodiment operates.

FIG. 12 is a flowchart of a getting-off support apparatus according to a fifth embodiment.

### DETAILED DESCRIPTION

While the present invention will be described below using embodiments of the invention, the invention according to the claims is not limited to the following embodiments. Further, all components described in the embodiments are not necessarily essential as means for solving the problem. To clarify the description, the following description and drawings include omission and are simplified as appropriate. Note that in the respective drawings, the same components are denoted by the same reference numerals, and repetitive description will be omitted as necessary.

### First Embodiment

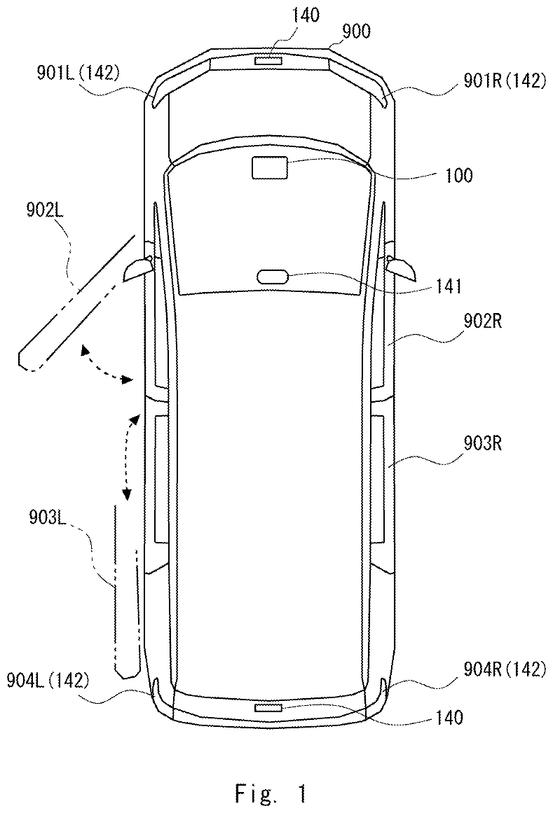

FIG. 1 is a view illustrating an own vehicle 900 according to a first embodiment. The own vehicle 900 is one aspect of a vehicle on which a getting-off support apparatus according to the present embodiment is mounted. The own vehicle 900 is a passenger vehicle that can carry approximately seven passengers.

The own vehicle 900 includes a right front door 902R, a left front door 902L, a right rear door 903R and a left rear door 903L as doors through which passengers can get on/off the own vehicle 900. The right front door 902R and the left front door 902L are swing doors that open while rotating about a support portion provided anteriorly. The right rear door 903R and the left rear door 903L are sliding doors that open by sliding backward of a vehicle body along rails provided on the vehicle body of the own vehicle 900.

Further, the own vehicle 900 includes a right front lamp 901R, a left front lamp 901L, a right rear lamp 904R and a left rear lamp 904L that are vehicle exterior warning apparatuses for causing vehicles, pedestrian, and the like, existing around the own vehicle 900 to recognize existence of the own vehicle 900. In other words, there is a case where the right front lamp 901R, the left front lamp 901L, the right rear lamp 904R and the left rear lamp 904L are collectively referred to as a vehicle exterior warning apparatus 142.

The right front lamp 901R, the left front lamp 901L, the right rear lamp 904R and the left rear lamp 904L may be one aspect of the vehicle exterior warning apparatus 142. The vehicle exterior warning apparatus 142 may be, for example, hazard lights of the own vehicle 900. Further, the vehicle exterior warning apparatus 142 may be a headlight or a brake light. Still further, the vehicle exterior warning apparatus 142 may be a light emission apparatus different from the above-described lights. Further, the vehicle exterior warning apparatus 142 is not limited to a light emission apparatus. The vehicle exterior warning apparatus 142 may be, for example, a speaker that emits speech having directivity.

Further, the own vehicle 900 includes a getting-off support apparatus 100, a ranging sensor 140 and a camera 141. The getting-off support apparatus 100 is communicatively connected to the ranging sensor 140, the camera 141, and the like, and performs support for getting-off operation that is operation of a user getting off the own vehicle 900. The getting-off support apparatus 100 can be provided at an arbitrary location of the own vehicle 900. The getting-off support apparatus 100 can be connected to a communication network (such as, for example, a controller area network (CAN)) of the own vehicle 900. Note that details of the getting-off support apparatus 100 will be described later.

The ranging sensor 140 detects an object existing around the own vehicle 900 and generates ranging data as data regarding a position and a distance of the detected object. The ranging sensors 140 are provided at a front portion and a rear portion of the own vehicle 900 and detect mobile objects which exist ahead and behind the own vehicle 900 and which are approaching the own vehicle 900.

The camera 141 is provided so as to be able to capture an image of a scene in a vehicle interior of the own vehicle 900. The camera 141 is, for example, provided at an arbitrary location of a windshield in the vehicle interior of the own vehicle 900. The camera 141 captures an image of getting-off operation of a passenger in the vehicle interior and supplies image data of the captured image to the getting-off support apparatus 100.

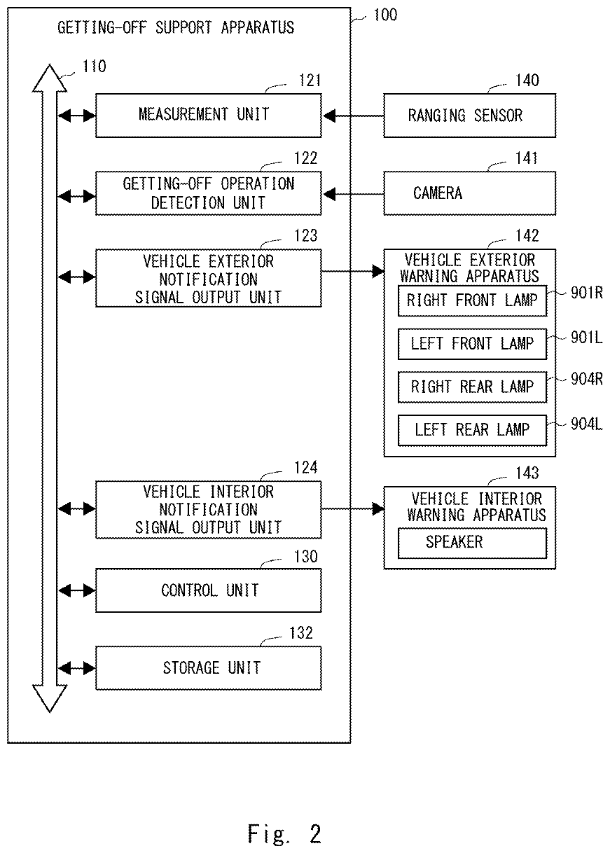

A configuration of the getting-off support apparatus 100 will be described next with reference to FIG. 2. FIG. 2 is a block diagram of the getting-off support apparatus 100 according to the first embodiment. The getting-off support apparatus 100 includes a measurement unit 121, a getting-off operation detection unit 122, a vehicle exterior notification signal output unit 123, a vehicle interior notification signal output unit 124, a control unit 130 and a storage unit 132 as main components of the getting-off support apparatus 100. Further, these components of the getting-off support apparatus 100 are communicatively connected via a communication bus 110 as appropriate. Note that the vehicle exterior notification signal output unit 123 and the vehicle interior notification signal output unit 124 which will be described in the following description may be collectively referred to as a “notification signal output unit”. While the vehicle exterior notification signal output unit 123 and the vehicle interior notification signal output unit 124 are described as different components for convenience of explanation, the vehicle exterior notification signal output unit 123 and the vehicle interior notification signal output unit 124 may be integrally constituted.

The measurement unit 121 receives the ranging data from the ranging sensor 140 and measures an approaching direction and moving velocity of the mobile object that is approaching the own vehicle 900, and a distance between the own vehicle 900 and the mobile object from the received ranging data. Further, the measurement unit 121 may identify a type of the mobile object. For example, the measurement unit 121 may identify whether the mobile object is an automobile, a two-wheeled vehicle, a pedestrian, or the like. The measurement unit 121 supplies measurement data that is a result of measurement to the control unit 130.

The getting-off operation detection unit 122 detects getting-off operation of a passenger in the own vehicle 900. Specifically, the getting-off operation detection unit 122 acquires the image data from the camera 141 and detects getting-off operation of a passenger from the acquired image data. The getting-off operation is, for example, operation of a passenger trying to get out of the own vehicle 900 from one of the doors. In a case where the getting-off operation detection unit 122 detects getting-off operation, the getting-off operation detection unit 122 supplies a signal indicating that the getting-off operation is detected, to the control unit 130. Note that the getting-off operation detection unit 122 may detect unlocking of a door lock or operation of a door handle as getting-off operation in a case where a state of the door lock or the door handle can be detected.

The vehicle exterior notification signal output unit 123 outputs a vehicle exterior notification signal for notifying the mobile object of existence of the own vehicle 900. The vehicle exterior notification signal is also referred to as a first notification signal. The vehicle exterior notification signal output unit 123 receives an instruction from the control unit 130 and outputs a signal that gives an instruction for lighting or blinking lamps for the purpose of giving warning to the mobile object existing around the own vehicle 900, to the vehicle exterior warning apparatus 142 in accordance with the received instruction.

The vehicle interior notification signal output unit 124 outputs a vehicle interior notification signal for notifying a passenger of approach of the mobile object. The vehicle interior notification signal is also referred to as a second notification signal. The vehicle interior notification signal output unit 124 receives an instruction from the control unit 130 and outputs a signal that gives an instruction for operating a speaker for the purpose of giving warning to a passenger who performs getting-off operation, to the vehicle interior warning apparatus 143 in accordance with the received instruction. Note that the warning to be given to the passenger by the vehicle interior warning apparatus 143 may be warning that calls attention for the getting-off operation or may be warning so as not to get off the vehicle.

The control unit 130 includes a processor such as, for example, a central processing unit (CPU), a micro processing unit (MPU) and a graphics processing unit (GPU) and performs control processing, arithmetic processing, and the like, in accordance with a predetermined program. The control unit 130 receives data or a signal from each component of the getting-off support apparatus 100 and gives an instruction for outputting a notification signal to the vehicle exterior notification signal output unit 123 or the vehicle interior notification signal output unit 124 from the received data or signal.

For example, if the control unit 130 receives the measurement data from the measurement unit 121, the control unit 130 determines whether or not the mobile object is approaching the own vehicle 900 from the received data. Further, if the control unit 130 receives a signal indicating that getting-off operation is detected from the getting-off operation detection unit 122, the control unit 133 determines whether or not to give an instruction to the vehicle exterior notification signal output unit 123 or the vehicle interior notification signal output unit 124 in accordance with the received signal. In other words, the control unit 130 controls output of the vehicle exterior notification signal and the vehicle interior notification signal in accordance with the distance and moving velocity of the mobile object in a case where getting-off operation is detected.

Further, specifically, for example, the control unit 130 estimates a period until when this mobile object reaches the own vehicle 900, from the distance and moving velocity of the approaching mobile object. Still further, the control unit 130 determines to output a vehicle exterior notification signal in a case where the estimated period is equal to or greater than a threshold set in advance. The control unit 130 performs such determination, because in a case where a period until when the mobile object reaches the own vehicle 900 and a predetermined period required for a passenger to get off the vehicle are compared, the predetermined period required for getting-off is sufficiently shorter, and thus, it can be considered that the passenger has enough time to get off the vehicle. Further, the control unit 130 determines to output a vehicle interior notification signal along with the vehicle exterior notification signal in a case where the estimated period is less than the threshold. The control unit 130 performs such determination, because in a case where the period until when the mobile object reaches the own vehicle 900 and the predetermined period required for the passenger to get off the vehicle are compared, it can be considered that the passenger does not have enough time to get off the vehicle. Note that the control unit 130 determines to output the vehicle interior notification signal to secure safety of the passenger inside the vehicle. The control unit 130 gives an instruction to the vehicle exterior notification signal output unit 123 and the vehicle interior notification signal output unit 124 as appropriate in accordance with the results of the determination.

Here, the threshold is set from the period required for the passenger to get off the vehicle. For example, typically, it is assumed that an average value of a period from when the passenger starts getting-off operation until when the passenger completes getting-off is 15 seconds. In this case, the threshold is set at, for example, 30 seconds which is longer than 15 seconds in view of a safety factor. Note that as the threshold, a fixed value may be set or, a plurality of values may be set in accordance with predetermined conditions (such as, for example, a position of a door and a type of a door).

The storage unit 132 is a storage device including a non-volatile memory such as, for example, a flash memory and a solid state drive (SSD). The storage unit 132, for example, stores a program to be executed by the control unit 130 or as a function of the control unit 130. Further, the storage unit 132 may include a volatile memory such as a dynamic random access memory (DRAM), in which case, the storage unit 132 may have a function for temporarily storing processing data, and the like.

Components connected to the getting-off support apparatus 100 will be described next. The getting-off support apparatus 100 is communicatively connected to the ranging sensor 140, the camera 141, the vehicle exterior warning apparatus 142 and the vehicle interior warning apparatus 143. The getting-off support apparatus 100 and these components may be individually connected or may be connected via a network such as CAN.

The ranging sensor 140 is communicatively connected to the measurement unit 121 and supplies the generated ranging data to the measurement unit 121. The ranging sensor 140, for example, generates image data as the ranging data for each of one thirtieth seconds. The ranging sensor 140 may be, for example, a sensor called light detection and ranging (LIDAR). Further, the ranging sensor 140 may be, for example, a sensor called time of flight (TOF), a millimeter-wave radar utilizing a millimeter wave, a sonar, or the like. Further, the ranging sensor 140 may be a stereo camera that captures an image of a common scene from separated positions.

The camera 141 is communicatively connected to the getting-off operation detection unit 122 and supplies image data related to the captured image to the getting-off operation detection unit 122. The camera 141, for example, generates image data for each of one thirtieth of seconds and supplies the generated image data to the getting-off operation detection unit 122.

The vehicle exterior warning apparatus 142 is communicatively connected to the vehicle exterior notification signal output unit 123 and operates in accordance with an instruction from the vehicle exterior notification signal output unit 123. The vehicle exterior warning apparatus 142 includes the right front lamp 901R, the left front lamp 901L, the right rear lamp 904R and the left rear lamp 904L. The vehicle exterior warning apparatus 142 can light or blink all of the lamps constituting the vehicle exterior warning apparatus 142 in accordance with content of the instruction. Further, the vehicle exterior warning apparatus 142 can light or blink part of the lamps constituting the vehicle exterior warning apparatus 142 in accordance with content of the instruction. Still further, in a case where the vehicle exterior warning apparatus 142 also functions as hazard lights (direction indicator lights), a light emission pattern of blinking of the hazard lights may be made different so as to be distinguished from blinking of hazard lights in a case where the own vehicle 900 is stopped on the side of a road.

The vehicle interior warning apparatus 143 is communicatively connected to the vehicle interior notification signal output unit 124 and operates in accordance with an instruction from the vehicle interior notification signal output unit 124. The vehicle interior warning apparatus 143 includes a speaker as one aspect. In other words, the vehicle interior warning apparatus 143 outputs speech that calls attention to the passenger who is performing getting-off operation in accordance with the instruction from the vehicle interior notification signal output unit 124.

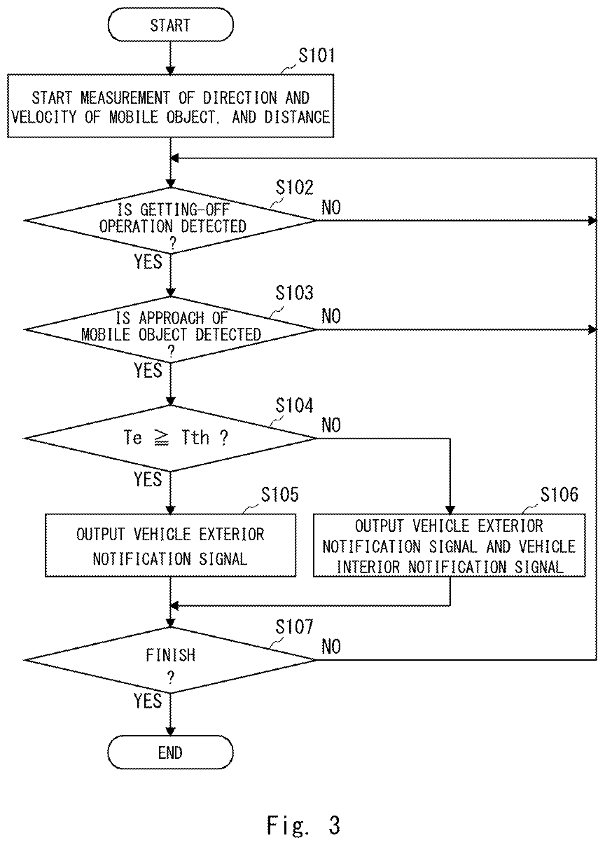

Processing to be executed by the getting-off support apparatus 100 will be described next with reference to FIG. 3. FIG. 3 is a flowchart of the getting-off support apparatus 100 according to the first embodiment. The flowchart indicated in FIG. 3 indicates processing to be executed by the control unit 130. Further, the flowchart indicated in FIG. 3 is started by, for example, the own vehicle 900 being stopped.

First, the control unit 130 causes the measurement unit 121 to start measurement of an approaching direction and moving velocity of the mobile object that is approaching the own vehicle, and a distance between the own vehicle and the mobile object (step S101), and the processing proceeds to step S102.

In step S102, the control unit 130 determines whether or not the getting-off operation detection unit 122 detects getting-off operation of a passenger (step S102). In a case where it is determined that the getting-off operation detection unit 122 detects getting-off operation of a passenger (step S102: Yes), the processing of the control unit 130 proceeds to step S103. On the other hand, in a case where it is not determined that the getting-off operation detection unit 122 detects getting-off operation of a passenger (step S102: No), the processing of the control unit 130 returns to step S102.

In step S103, the control unit 130 determines whether or not approach of the mobile object is detected from data as a result of measurement by the measurement unit 121 (step S103). In a case where it is determined that approach of the mobile object is detected (step S103: Yes), the processing of the control unit 130 proceeds to step S104. On the other hand, in a case where it is not determined that approach of the mobile object is detected (step S103: No), the processing of the control unit 130 returns to step S102.

In step S104, the control unit 130 estimates an estimated period Te that is a period until when the mobile object reaches the own vehicle 900, from the distance and the moving velocity of the approaching mobile object. Further, the control unit 130 compares the estimated period Te with a threshold Tth set in advance. Then, the control unit 130 determines whether or not the estimated period Te is equal to or greater than the threshold Tth (step S104). In a case where it is determined that the estimated period Te is equal to or greater than the threshold Tth (step S104: Yes), the processing of the control unit 130 proceeds to step S105. On the other hand, in a case where it is not determined that the estimated period Te is equal to or greater than the threshold Tth (step S104: No), the processing of the control unit 130 proceeds to step S106.

Here, a case where the own vehicle 900 is stopped on a general road and a passenger gets off the own vehicle 900 in a case where the threshold Tth is set at, for example, 30 seconds, will be described. In this case, if the control unit 130 determines that getting-off operation is detected, the control unit 130 further determines whether or not a mobile object approaching the own vehicle 90 is detected. Here, for example, it is assumed that the ranging sensor 140 detects approach of a bicycle. In this case, the measurement unit 121 receives ranging data from the ranging sensor 140 and measures a distance to the bicycle that is approaching the own vehicle 900 as, for example, 100 meters, and moving velocity as 10 kilometers per hour. The control unit 130 estimates a period until when the bicycle reaches the own vehicle 900 as 36 seconds (Te=(100/10000/3600)=36), from the distance to the bicycle and the moving velocity of the bicycle. Further, the control unit 130 compares the calculated estimated period Te=36 with the threshold Tth=30. In this case, the estimated period Te is equal to or greater than the threshold Tth. Thus, the processing of the control unit 130 proceeds to step S105.

In step S105, the control unit 130 gives an instruction for causing the vehicle exterior notification signal output unit 123 to output the vehicle exterior notification signal (step S105). The vehicle exterior notification signal output unit 123 outputs a signal for performing warning operation to the vehicle exterior warning apparatus 142 in response to the instruction from the control unit 130. By this means, the own vehicle 900 performs operation for giving warning to the mobile object that is approaching the own vehicle 900. After the above-described processing, the processing of the control unit 130 proceeds to step S107.

In step S106, the control unit 130 gives an instruction for causing the vehicle exterior notification signal output unit 123 to output the vehicle exterior notification signal and gives an instruction for causing the vehicle interior notification signal output unit 124 to output the vehicle interior notification signal (step S106). The vehicle exterior notification signal output unit 123 outputs a signal for performing warning operation to the vehicle exterior warning apparatus 142 in response to the instruction from the control unit 130. By this means, the own vehicle 900 performs operation for giving warning to the mobile object that is approaching the own vehicle 900. Further, the vehicle interior notification signal output unit 124 outputs a signal for performing warning operation to the vehicle interior warning apparatus 143 in response to the instruction from the control unit 130. By this means, the own vehicle 900 performs operation for giving warning that the mobile object is approaching the own vehicle 900 to the passenger. After the above-described processing, the processing of the control unit 130 proceeds to step S107.

In step S107, the control unit 130 determines whether or not to finish a series of processing (step S107). The determination as to whether or not to finish a series of processing may be performed by, for example, the control unit 130 detecting whether the own vehicle 900 is in a stopped state or in a moving state. In this case, in a case where the control unit 130 detects that the own vehicle 900 starts moving, the control unit 130 determines to finish a series of processing. Further, the determination as to whether or not to finish a series of processing may be, for example, detection as to whether the control unit 130 accepts operation of giving an instruction to stop processing by the user. Further, the determination as to whether or not to finish a series of processing may be, for example, determination as to whether a passenger in the vehicle interior of the own vehicle 900 is no longer detected by the control unit 130. In a case where it is not determined to finish a series of processing (step S107: No), the processing returns to step S102, and the control unit 130 continues the processing. On the other hand, in a case where it is determined to finish a series of processing (step S107: Yes), the control unit 130 finishes a series of processing.

The getting-off support method to be executed by the getting-off support apparatus 100 in the first embodiment has been described above. As described above, in a case where getting-off operation is detected, the getting-off support apparatus 100 controls output of the vehicle exterior notification signal and the vehicle interior notification signal in accordance with the distance and the moving velocity of the mobile object. In a case where a period until when the mobile object reaches the own vehicle 900 is relatively long, the getting-off support apparatus 100 issues warning to the mobile object outside the vehicle and does not issue warning that prevents getting-off operation to encourage the passenger to perform rapid getting-off operation. On the other hand, in a case where the period until when the mobile object reaches the own vehicle 900 is relatively short, the getting-off support apparatus 100 issues warning to the mobile object outside the vehicle and also notifies the passenger of approach of the mobile object to call attention.

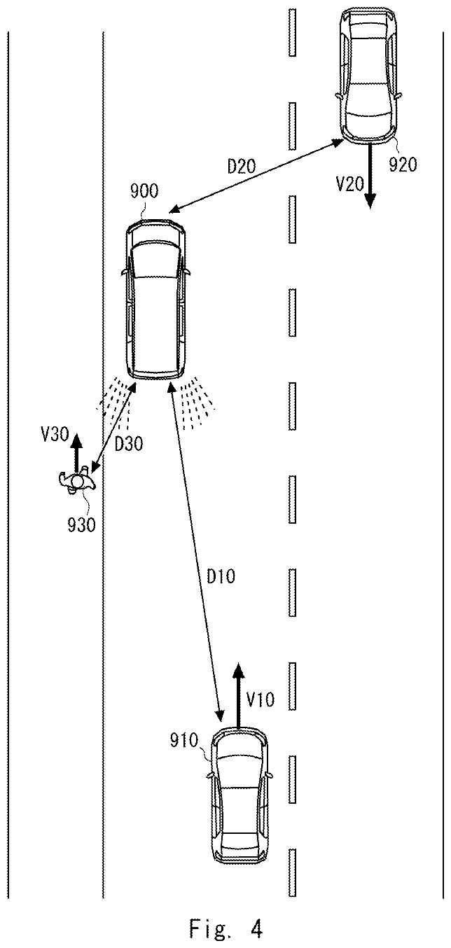

An example of circumstances where the getting-off support apparatus 100 executes the above-described getting-off support method will be described next with reference to FIG. 4. FIG. 4 is a view illustrating an example of circumstances where the getting-off support apparatus according to the first embodiment operates. FIG. 4 is a view of a road observed from an upper surface. FIG. 4 includes the own vehicle 900, another vehicle 910, another vehicle 920 and a pedestrian 930 existing on the road. The own vehicle 900 is stopped at an edge of the road. Further, inside the own vehicle 900, a passenger tries to get off the own vehicle 900.

The other vehicle 910 is approaching the own vehicle 900 from behind the own vehicle 900. In the circumstances illustrated in FIG. 4, a distance between the other vehicle 910 and the own vehicle 900 is a distance D10. Further, in the circumstances illustrated in FIG. 4, the other vehicle 910 is approaching the own vehicle 900 at velocity V10.

The other vehicle 920 is traveling near the own vehicle 900 on an opposing lane of a lane on which the own vehicle 900 is stopped. In the circumstances illustrated in FIG. 4, a distance between the other vehicle 920 and the own vehicle 900 is a distance D20. Further, in the circumstances illustrated in FIG. 4, the other vehicle 920 is moving at velocity V20.

The pedestrian 930 is walking on a pavement on a side on which the own vehicle 900 is stopped. In the circumstances illustrated in FIG. 4, a distance between the pedestrian 930 and the own vehicle 900 is a distance D30. Further, in the circumstances illustrated in FIG. 4, the pedestrian 930 is approaching the own vehicle 900 at velocity V30.

In the above-described circumstances, the getting-off support apparatus 100 mounted on the own vehicle 900 detects the other vehicle 920, the other vehicle 910 and the pedestrian 930 that are mobile objects existing around the own vehicle 900. Further, the getting-off support apparatus 100 measures positions of the respective mobile objects, approaching directions and moving velocities of the mobile objects, and distances between the own vehicle 900 and each mobile object.

In a case of the example illustrated in FIG. 4, it is assumed that a period until when the other vehicle 910 reaches the own vehicle 900 is equal to or greater than the threshold Tth. In this case, the getting-off support apparatus 100 issues a warning signal for notifying the other vehicle 910 of getting-off operation.

In a case of the example illustrated in FIG. 4, the getting-off support apparatus 100 does not determine that the other vehicle 920 is approaching the own vehicle 900 from the position and the moving direction of the other vehicle 920. In this case, the getting-off support apparatus 100 does not issue a warning signal for notifying the other vehicle 920 of getting-off operation.

In a case of the example illustrated in FIG. 4, it is assumed that a period until when the pedestrian 930 reaches the own vehicle 900 is less than the threshold Tth. In this case, the getting-off support apparatus 100 issues a warning signal for notifying the pedestrian 930 of getting-off operation and issues a warning signal for notifying the passenger inside the vehicle of approach of the mobile object. Further, in this event, to prevent the pedestrian 930 from being frightened at the warning signal, for example, a volume of a horn may be lowered, or a light amount of a light may be lowered. Note that in this case, in a case where it is detected that the mobile object is a pedestrian, the getting-off support apparatus 100 may issue a speech message of notifying the passenger that the pedestrian 930 is approaching.

Note that the getting-off support apparatus 100 has a function as a computer that is an arithmetic apparatus. Further, the getting-off support apparatus 100 can implement functions according to the above-described components by a program stored in the storage unit 132 being executed by a processor of the control unit 130. Still further, each component of the getting-off support apparatus 100 may be implemented by any combination of hardware and software, or the like, as well as being implemented by software by the program. Further, each component of the getting-off support apparatus 100 may be implemented using an integrated circuit that can be programmed by a user, such as, for example, a field-programmable gate array (FPGA), a system on a chip (SOC) and a microcomputer. In this case, the program constituted from the above-described each component may be implemented using this integrated circuit. This similarly applies to other embodiments which will be described later.

The first embodiment has been described above. Note that the getting-off support apparatus 100 mounted on the own vehicle 900 may be provided so as to be detachable from a system of the own vehicle 900 and constituted as an independent single apparatus. Further, the getting-off support apparatus 100 may be constituted as part of the system of the own vehicle 900. According to the first embodiment, it is possible to provide a getting-off support apparatus that performs preferred getting-off support, a getting-off support method and a program.

### Second Embodiment

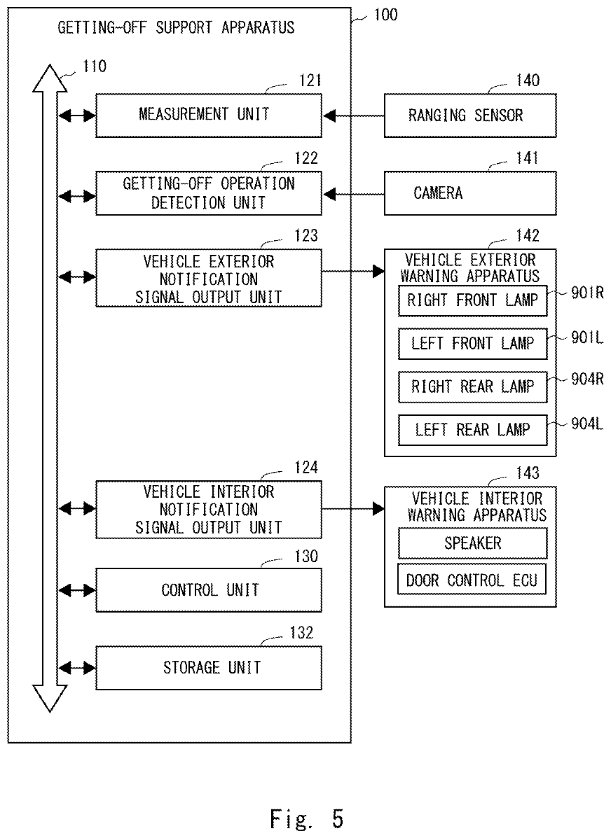

A second embodiment will be described next. The second embodiment is different from the first embodiment in processing of the control unit 130 and a signal to be output by the vehicle interior notification signal output unit 124. FIG. 5 is a block diagram of a getting-off support apparatus according to the second embodiment.

The vehicle interior notification signal output unit 124 in the present embodiment is connected so as to be able to output a predetermined signal to a door control ECU, as the vehicle interior warning apparatus 143. The door control ECU, which is a control apparatus of the own vehicle 900, monitors an open/closed state of a door and a position of a door and controls a lock device of the door. Further, the door control ECU controls opening operation and closing operation of a sliding door.

The vehicle interior notification signal output unit 124, for example, can output an instruction for operating the lock device of the door to the door control ECU in response to an instruction from the control unit 130. Further, the vehicle interior notification signal output unit 124 can output an instruction for stopping movement of the sliding door.

The control unit 130 in the present embodiment determines to output the vehicle interior notification signal in a case where, concerning the mobile object for which the estimated period until when the mobile object reaches the own vehicle 900 is equal to or greater than the threshold, a distance to the mobile object is less than a limit distance set in advance and velocity of the mobile object is equal to or greater than limit velocity set in advance. In this case, the control unit 130 can supply the vehicle interior notification signal for indicating that getting-off operation is dangerous because the mobile object is approaching.

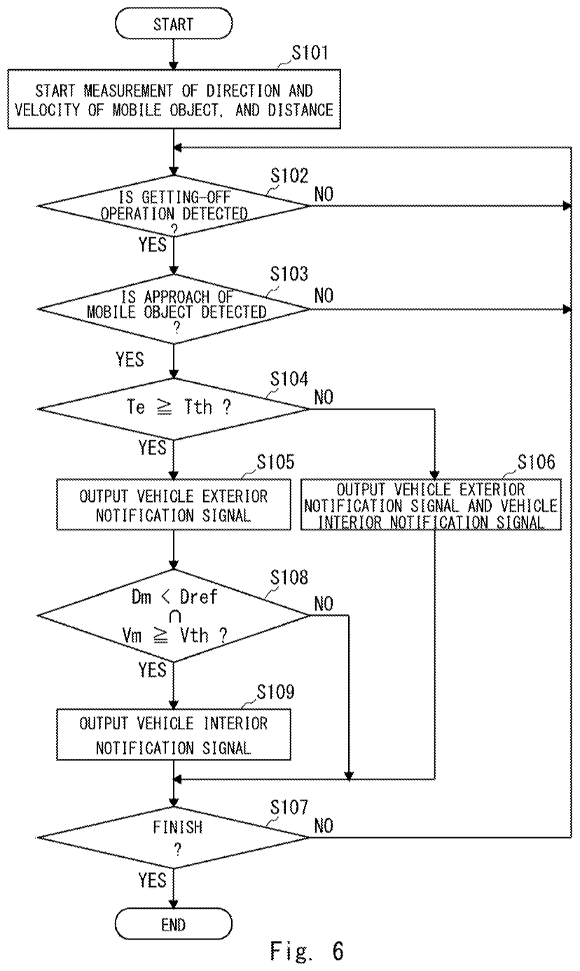

A getting-off support method in the second embodiment will be described with reference to FIG. 6. FIG. 6 is a flowchart of the getting-off support apparatus according to the second embodiment. The flowchart indicated in FIG. 6 is different from the flowchart indicated in FIG. 3 in processing after step S105. In other words, if the processing in step S105 ends, the processing of the control unit 130 proceeds to step S108.

In step S108, the control unit 130 determines whether or not a distance Dm of the mobile object which is being measured is less than a limit distance Dref set in advance, and velocity Vm of the mobile object is equal to or greater than limit velocity Vth (step S108). In a case where it is not determined that the above-described conditions are satisfied (step S108: No), the processing of the control unit 130 proceeds to step S107. On the other hand, in a case where it is determined that the above-described conditions are satisfied (step S108: Yes), the processing of the control unit 130 proceeds to step S109.

The above-described processing will be described using specific examples. For example, it is assumed that the limit distance Dref for the mobile object that is approaching the own vehicle 900 that is stopped is set at 20 meters, and the limit velocity Vth of the mobile object is set at 10 kilometers per hour. In other words, there is a possibility that the mobile object that is approaching the own vehicle 900 at velocity of equal to or higher than 10 kilometers per hour from a distance within 20 meters from the own vehicle 900 may come into contact with the passenger who is getting off the own vehicle 900. Thus, the above-described conditions are set at the getting-off support apparatus 100.

In this case, the measurement unit 121, for example, measures the distance and the moving velocity of the mobile object that is approaching the own vehicle 900 from the ranging data supplied from the ranging sensor 140. Further, in a case where the distance to the mobile object is less than 20 that is the limit distance Dref, the control unit 130 compares the moving velocity Vm of the mobile object and 10 kilometers per hour that is the limit velocity Vth. In a case where the moving velocity Vm of the mobile object is equal to or higher than 10 kilometers per hour, the control unit 130 determines that the above-described conditions are satisfied, and the processing proceeds to step S109.

In step S109, the control unit 130 gives an instruction for causing the vehicle interior notification signal output unit 124 to output the vehicle interior notification signal (step S109). By this means, the getting-off support apparatus 100 can call attention to the passenger in the getting-off operation in a case where the mobile object that is approaching at velocity equal to or higher than predetermined velocity exists. Alternatively, the getting-off support apparatus 100 can prevent getting-off operation of the passenger. This enables the getting-off support apparatus 100 to prevent lowering of safety of getting-off operation to be performed by the passenger. If the control unit 130 finishes the above-described processing, the processing proceeds to step S107.

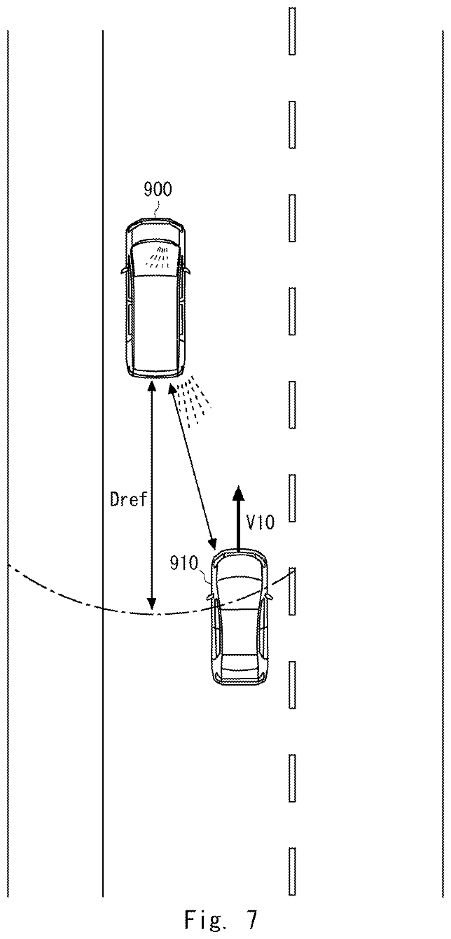

FIG. 7 is a view illustrating an example of circumstances where the getting-off support apparatus according to the second embodiment operates. In FIG. 7, the other vehicle 910 is approaching the own vehicle 900 while keeping the velocity V10, and the other vehicle 910 is approaching the own vehicle 900 to a distance less than the distance Dref. Thus, the getting-off support apparatus 100 issues vehicle interior warning for causing the passenger to call attention. In this event, the own vehicle 900 may limit operation of doors or may cause lock of doors to operate. This enables the getting-off support apparatus 100 to prevent lowering of safety of getting-off operation.

The second embodiment has been described above. According to the second embodiment, it is possible to provide a getting-off support apparatus that performs preferred getting-off support, a getting-off support method, and a program.

### Third Embodiment

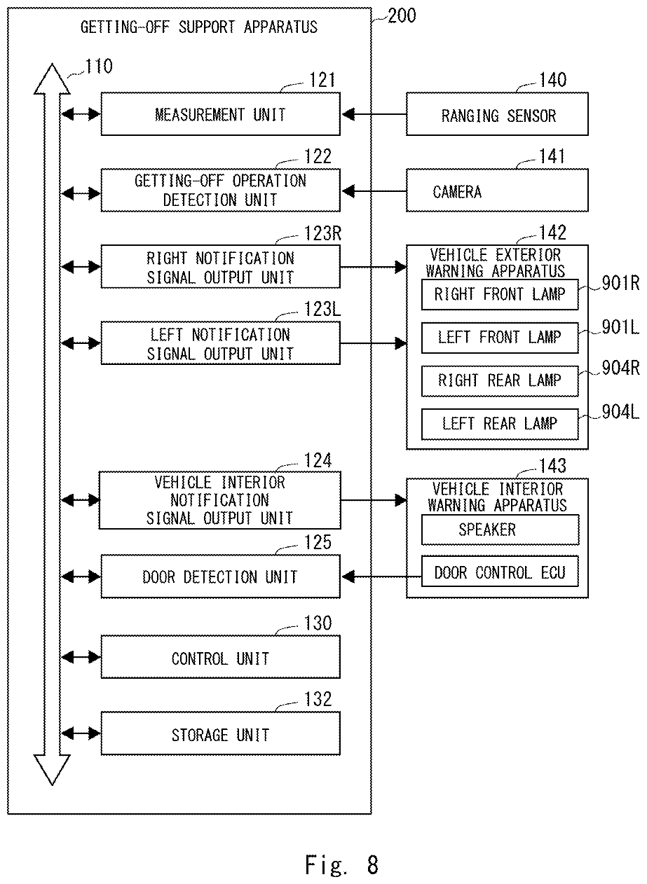

A third embodiment will be described next. FIG. 8 is a block diagram of a getting-off support apparatus according to the third embodiment. FIG. 8 illustrates a block diagram of a getting-off support apparatus 200 according to the third embodiment. The getting-off support apparatus 200 includes a right notification signal output unit 123R and a left notification signal output unit 123L in place of the vehicle exterior notification signal output unit 123. Further, the getting-off support apparatus 200 includes a door detection unit 125. Note that the right notification signal output unit 123R, the left notification signal output unit 123L and the vehicle interior notification signal output unit 124 may be collectively referred to as a “notification signal output unit”. While the right notification signal output unit 123R, the left notification signal output unit 123L and the vehicle interior notification signal output unit 124 are described as different components for convenience of explanation, the right notification signal output unit 123R, the left notification signal output unit 123L and the vehicle interior notification signal output unit 124 may be integrally constituted.

The right notification signal output unit 123R receives an instruction from the control unit 130 and outputs a vehicle exterior notification signal (which will be also referred to as a third notification signal) for notifying a mobile object that is approaching a right side of the own vehicle 900 of existence of the own vehicle 900 in response to the received instruction. More specifically, the right notification signal output unit 123R outputs a signal (third notification signal) for causing the right front lamp 901R and the right rear lamp 904R of the vehicle exterior warning apparatus 142 to operate, to the vehicle exterior warning apparatus 142.

The left notification signal output unit 123L receives an instruction from the control unit 130 and outputs a vehicle exterior notification signal (which will be also referred to as a fourth notification signal) for notifying a mobile object that is approaching a left side of the own vehicle 900 of existence of the own vehicle 900 in response to the received instruction. More specifically, the left notification signal output unit 123L outputs a signal (fourth notification signal) for causing the left front lamp 901L and the left rear lamp 904L of the vehicle exterior warning apparatus 142 to operate, to the vehicle exterior warning apparatus 142.

The door detection unit 125 detects a position and movement of a door of the own vehicle. For example, the door detection unit 125 can detect the door based on the image data acquired from the camera 141. Further, the door detection unit 125 may acquire data regarding the position and movement of the door from the door control ECU. If the door detection unit 125 detects the position and movement of the door, the door detection unit 125 supplies a signal indicating that the position and movement of the door are detected, to the control unit 130.

In a case where getting-off operation is detected, and in a case where a position of the door from which the passenger gets off the own vehicle matches a side on which the mobile object approaches, the control unit 130 in the present embodiment controls output of a notification signal corresponding to the side. In other words, the control unit 130 determines to which side of the own vehicle 900, a direction in which the mobile object approaches the own vehicle is close, from the measurement data acquired from the measurement unit 121. Further, the control unit 130 detects the side on which the passenger tries to get off the own vehicle from data regarding the getting-off operation acquired from the getting-off operation detection unit 122, data acquired from the door detection unit 125 or data acquired from both. Then, the control unit 130 checks the position of the door from which the passenger gets off the own vehicle against the side on which the mobile object approaches, and in a case where the position of the door matches the side, the control unit 130 gives an instruction to the right notification signal output unit 123R or the left notification signal output unit 123L so that the vehicle exterior warning apparatus 142 on the corresponding side operates.

Note that the vehicle interior notification signal output unit 124 in the present embodiment may be set so as to compare the position of the door from which the passenger tries to get off the own vehicle and the direction in which the mobile object approaches the own vehicle and issue warning that the mobile object is approaching the door from which the passenger tries to get off the own vehicle. Further, the vehicle interior notification signal output unit 124 may be set so as to output a message that encourages the passenger to use a door on a side on which the mobile object is not approaching.

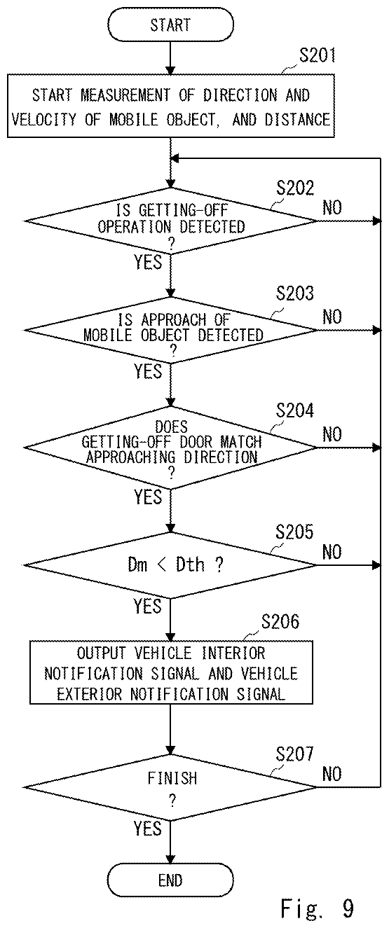

Processing to be executed by the getting-off support apparatus 200 according to the third embodiment will be described next with reference to FIG. 9. FIG. 9 is a flowchart of the getting-off support apparatus according to the third embodiment. The flowchart indicated in FIG. 9 indicates processing to be executed by the control unit 130. Further, the flowchart indicated in FIG. 9 is started by, for example, the own vehicle 900 being stopped.

First, the control unit 130 causes the measurement unit 121 to start measurement of an approaching direction and moving velocity of the mobile object that approaches the own vehicle, and a distance between the own vehicle and the mobile object (step S201), and the processing proceeds to step S202.

In step S202, the control unit 130 determines whether or not the getting-off operation detection unit 122 detects getting-off operation of a passenger (step S202). In a case where it is determined that the getting-off operation detection unit 122 detects getting-off operation of a passenger (step S202: Yes), the processing of the control unit 130 proceeds to step S203. On the other hand, in a case where it is not determined that the getting-off operation detection unit 122 detects getting-off operation of a passenger (step S202: No), the control unit 130 repeats the processing in step S202.

In step S203, the control unit 130 determines whether or not approach of a mobile object is detected from data as a result of measurement by the measurement unit 121 (step S203). In a case where it is determined that approach of a mobile object is detected (step S203: Yes), the processing of the control unit 130 proceeds to step S204. On the other hand, in a case where it is not determined that approach of a mobile object is detected (step S203: No), the processing of the control unit 130 returns to step S202.

In step S204, the control unit 130 determines whether or not the door related to the getting-off operation matches the approaching direction of the mobile object (step S204). In a case where it is determined that the door related to the getting-off operation matches the approaching direction of the mobile object (step S204: Yes), the processing of the control unit 130 proceeds to step S205. On the other hand, in a case where it is not determined that the door related to the getting-off operation matches the approaching direction of the mobile object (step S204: No), the processing of the control unit 130 returns to step S202.

In step S205, the control unit 130 determines whether or not the distance Dm to the approaching mobile object is less than the distance Dth that is a threshold distance set in advance (step S205). In a case where it is determined that the distance Dm to the approaching mobile object is less than the distance Dth (step S205: Yes), the processing of the control unit 130 proceeds to step S206. On the other hand, in a case where it is not determined that the distance Dm to the approaching mobile object is less than the distance Dth (step S205: No), the processing of the control unit 130 returns to step S202.

In step S206, the control unit 130 performs processing of causing the vehicle interior notification signal and the vehicle exterior notification signal to be output (step S206). More specifically, the control unit 130 causes the vehicle interior notification signal output unit 124 to output the vehicle interior notification signal. Further, the control unit 130 gives an instruction to output the notification signal to the notification signal output unit (that is, one or both of the right notification signal output unit 123R and the left notification signal output unit 123L) corresponding to the side on which conditions in step S204 are satisfied. By this means, the getting-off support apparatus 200 drives the vehicle exterior warning apparatus 142 corresponding to the side on which the mobile object is approaching. After the above-described processing is finished, the processing of the control unit 130 transitions to step S207.

Then, in step S207, the control unit 130 determines whether or not to finish a series of processing (step S207). Here, the processing to be executed by the control unit 130 is the same as the processing indicated as step S107 in the flowchart in FIG. 3. Thus, subsequent description will be omitted.

The getting-off support method to be executed by the getting-off support apparatus 200 in the third embodiment has been described above. As described above, the getting-off support apparatus 200 performs processing of driving the warning apparatus in a case where getting-off operation is detected and in a case where the position of the door related to the getting-off operation matches the approaching direction of the mobile object. This enables the getting-off support apparatus 200 in the present embodiment to efficiently execute getting-off support. In other words, according to the present embodiment, it is possible to provide a getting-off support apparatus that performs preferred getting-off support, a getting-off support method, and a program.

### Fourth Embodiment

A fourth embodiment will be described next. A configuration of the getting-off support apparatus 200 according to the fourth embodiment is similar to the configuration illustrated in FIG. 8. However, the fourth embodiment is different from the third embodiment in a function of the door detection unit 125 and a function of the control unit 130 corresponding to the function of the door detection unit 125.

The door detection unit 125 in the present embodiment identifies whether a type of the door of the own vehicle 900 is a swing door or a sliding door. Data regarding the type of the door identified by the door detection unit 125 is, for example, stored in the storage unit 132. The door detection unit 125 identifies types of all the doors of the own vehicle 900.

Further, the control unit 130 in the present embodiment determines with which of the doors, getting-off operation is associated. By this means, in a case where the getting-off operation is associated with a swing door, the control unit 130 determines to output the notification signal in a case where a distance between the own vehicle 900 and the mobile object is less than a first distance that is a threshold distance set in advance. Further, in a case where the getting-off operation is associated with a sliding door, the control unit 130 determines to output the notification signal in a case where the distance is less than a second distance which is a threshold distance set in advance and which is greater than the first distance. According to such a configuration, the getting-off support apparatus 200 can preferably perform getting-off support.

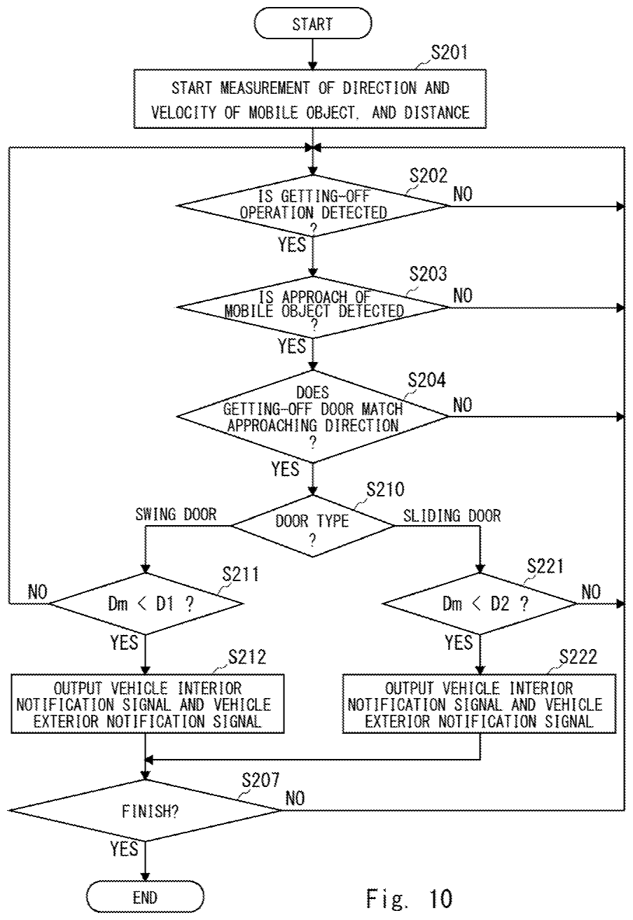

FIG. 10 is a flowchart of the getting-off support apparatus according to the fourth embodiment. The flowchart indicated in FIG. 10 is different from the flowchart indicated in FIG. 9 in processing after step S204 to before step S207.

In a case where the control unit 130 determines that the getting-off door matches the approaching direction in step S204 (step S204: Yes), the processing of the control unit 130 proceeds to step S210.

In step S210, the control unit 130 determines a type of the door related to the getting-off operation (step S210). In a case where it is determined that the type of the door related to the getting-off operation is a swing door (a left side in step S210), the processing of the control unit 130 proceeds to step S211. On the other hand, in a case where it is determined that the type of the door related to the getting-off operation is a sliding door (a right side in step S210), the processing of the control unit 130 proceeds to step S221.

In step S211, the control unit 130 determines whether or not the distance Dm to the approaching mobile object is less than the first distance D1 that is the threshold distance set in advance (step S211). In a case where it is determined that the distance Dm to the approaching mobile object is less than the first distance D1 (step S211: Yes), the processing of the control unit 130 proceeds to step S212. On the other hand, in a case where the distance Dm to the approaching mobile object is less than the first distance D1 (step S211: No), the processing of the control unit 130 returns to step S202.

In step S212, the control unit 130 performs processing of causing the vehicle interior notification signal and the vehicle exterior notification signal to be output (step S212). The control unit 130 gives an instruction to output the notification signal to the notification signal output unit corresponding to the side on which the conditions in step S204 are satisfied. After the above-described processing is finished, the processing of the control unit 130 transitions to step S207.

In step S221, the control unit 130 determines whether or not the distance Dm to the approaching mobile object is less than the second distance D2 that is the threshold distance set in advance (step S221). In a case where it is determined that the distance Dm to the approaching mobile object is less than the second distance D2 (step S221: Yes), the processing of the control unit 130 proceeds to step S222. On the other hand, in a case where it is not determined that the distance Dm to the approaching mobile object is less than the second distance D2 (step S221: No), the processing of the control unit 130 returns to step S202.

In step S222, the control unit 130 performs processing of causing the vehicle interior notification signal and the vehicle exterior notification signal to be output (step S222). The control unit 130 issues an instruction to output the notification signal to the notification signal output unit corresponding to the side on which the conditions in step S204 are satisfied. After the above-described processing is finished, the processing of the control unit 130 transitions to step S207.

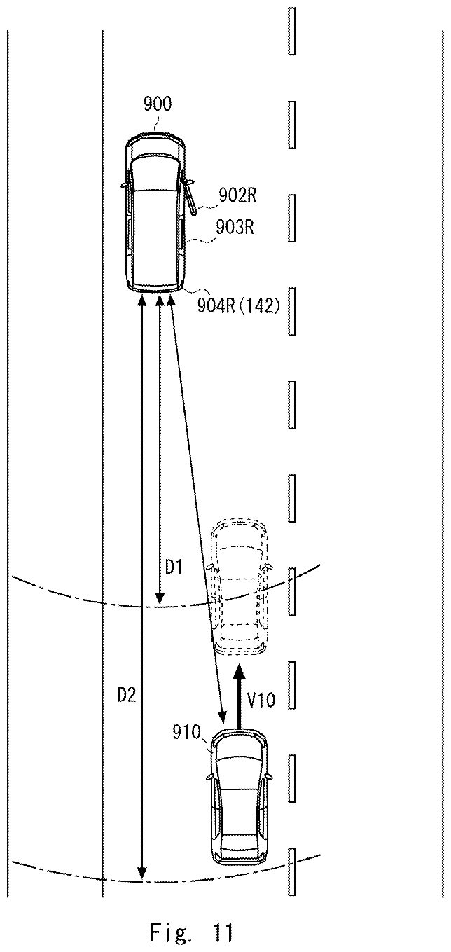

FIG. 11 is a view illustrating an example of circumstances where the getting-off support apparatus according to the fourth embodiment operates. In FIG. 11, the other vehicle 910 is approaching behind the right side of the own vehicle 900 at the velocity V10, and the other vehicle 910 exists at a distance greater than the first distance D1 and less than the second distance D2. Further, the passenger of the own vehicle 900 tries to get off the own vehicle 900 by utilizing the right front door 902R.

In the above-described circumstances, the getting-off support apparatus 200 detects the other vehicle 910 that is the mobile object and detects that the other vehicle 910 is approaching the right side of the own vehicle 900. Further, the getting-off support apparatus 200 detects getting-off operation of the passenger and detects that the getting-off operation is associated with the right front door 902R. Still further, the control unit 130 determines that the position (right side) of the door related to the getting-off operation matches the direction (right side) of the approaching other vehicle 910. Further, the control unit 130 identifies that the door related to getting-off (right front door 902R) is a swing door. Still further, the control unit 130 determines whether or not the distance to the other vehicle 910 is less than the first distance D1.

In FIG. 11, the other vehicle 910 exists at a distance greater than the first distance D1. Thus, the getting-off support apparatus 200 does not execute processing for driving the warning apparatus of the own vehicle 900 in this circumstances. Note that it can be recognized, from the other vehicle 910, that the swing door on the right side of the own vehicle 900 is open. Here, the own vehicle 900 is sufficiently separated from the other vehicle 910 in FIG. 11 in view of safety. Thus, in FIG. 11, the passenger can perform getting-off operation without the getting-off support apparatus 200 performing processing for giving warning.

However, in a case where the other vehicle 910 moves to a position indicated with a dotted line before the getting-off operation is completed, the getting-off support apparatus 200 performs processing different from the above-described processing. In other words, in this case, the getting-off support apparatus 200 determines that the other vehicle 910 exists at a distance shorter than the first distance D1. Thus, the getting-off support apparatus 200 drives the right rear lamp 904R to issue warning to the other vehicle 910. Further, the getting-off support apparatus 200 issues warning for notifying the passenger also of approach of the mobile object.

Note that in a case where the passenger tries to get off the own vehicle 900 from the right rear door 903R that is a sliding door in a case where the other vehicle 910 exists at the position in FIG. 11, that is, in a case where the other vehicle 910 exists at a distance less than the second distance D2, the getting-off support apparatus 200 performs processing of driving the warning apparatus, because an opening state of the sliding door is difficult to be visually confirmed from a distance compared to an opening state of the swing door. In this manner, the getting-off support apparatus 200 sets the threshold distance greater for the getting-off operation associated with the sliding door than for the getting-off operation associated with the swing door. This enables the getting-off support apparatus 200 to efficiently execute getting-off support further in view of safety.

The fourth embodiment has been described above. According to the fourth embodiment, it is possible to provide a getting-off support apparatus that efficiently performs preferred getting-off support, a getting-off support method, and a program.

### Fifth Embodiment

A fifth embodiment will be described next. The getting-off support apparatus 200 according to the fifth embodiment is different from the fourth embodiment in order of processing of the warning apparatus.

The control unit 130 in the present embodiment outputs the vehicle exterior notification signal after the vehicle interior notification signal in a case where the getting-off operation is associated with a swing door, and outputs the vehicle exterior notification signal before or at the same time as the vehicle interior notification signal in a case where the getting-off operation is associated with a sliding door. This enables the getting-off support apparatus 200 to give warning in preferred order.

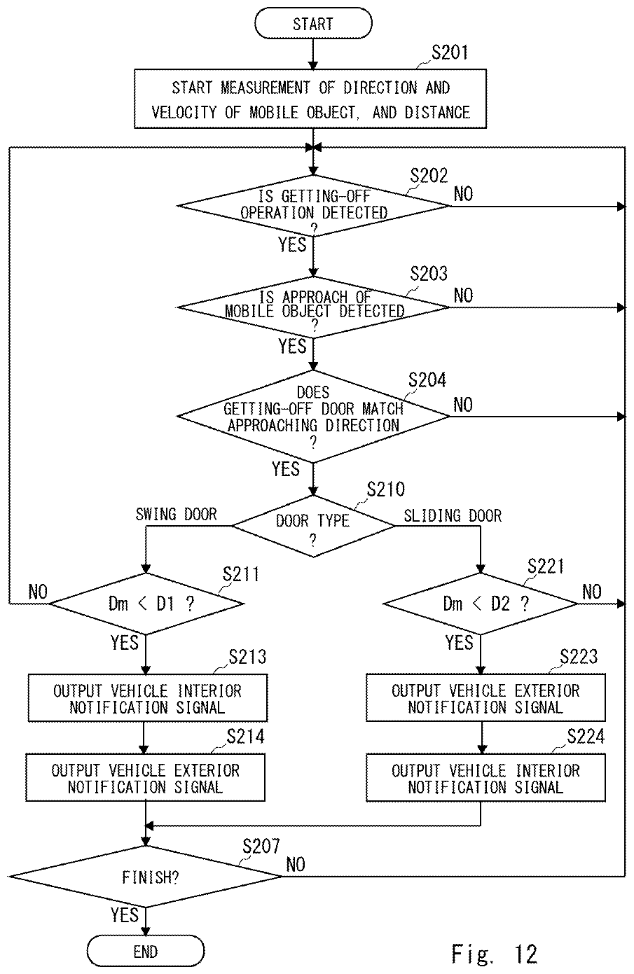

FIG. 12 is a flowchart of the getting-off support apparatus according to the fifth embodiment. The flowchart in FIG. 12 is different in processing after step S211 and processing after step S221.

In step S211, in a case where the control unit 130 determines that the distance Dm to the approaching mobile object is less than the first distance D1 (step S211: Yes), the processing of the control unit 130 proceeds to step S213, and the control unit 130 first causes the vehicle interior notification signal to be output (step S213). Then, after the control unit 130 causes the vehicle interior notification signal to be output, the control unit 130 causes the vehicle exterior notification signal to be output (step S214), and the processing proceeds to step S207. In other words, in the present embodiment, in a case where a type of the door corresponding to the getting-off operation is a swing door, the getting-off support apparatus 200 prioritizes output of the vehicle interior notification signal over output of the vehicle exterior notification signal.

On the other hand, in step S221, in a case where the control unit 130 determines that the distance Dm to the approaching mobile object is less than the second distance D2 (step S221: Yes), the processing of the control unit 130 proceeds to step S223, and the control unit 130 first causes the vehicle exterior notification signal to be output (step S223). Then, after the control unit 130 causes the vehicle exterior notification signal to be output, the control unit 130 causes the vehicle interior notification signal to be output (step S224), and the processing proceeds to step S207. In other words, in the present embodiment, in a case where a type of the door corresponding to the getting-off operation is a sliding door, the getting-off support apparatus 200 prioritizes output of the vehicle exterior notification signal over output of the vehicle interior notification signal.

The fifth embodiment has been described above. The getting-off support apparatus 200 according to the fifth embodiment effectively performs processing in view of safety. By this means, according to the fifth embodiment, it is possible to provide a getting-off support apparatus that performs more preferred getting-off support, a getting-off support method, and a program.

Note that the above-described program can be stored using various types of non-transitory computer-readable media and supplied to a computer. The non-transitory computer-readable media include various types of tangible recording media. Examples of the non-transitory computer-readable media include a magneto optical recording medium (for example, an optical magnetic disk), a CD-ROM (read only memory) CD-R, a CD-R/W, and a semiconductor memory (for example, a mask ROM, a programmable ROM (PROM), an erasable PROM (EPROM), a flash ROM and a random access memory (RAM)). Further, the program may be supplied to a computer using various types of transitory computer-readable media. Examples of the transitory computer-readable media include an electric signal, an optical signal and an electromagnetic wave. A transitory computer-readable medium can supply the program to a computer via a wired communication path such as an electric wire and an optical fiber or a wireless communication path.

Note that the present invention is not limited to the above-described embodiments and can be changed as appropriate within a scope not deviating from the gist.

A getting-off support apparatus according to the present embodiment can be utilized for, for example, supporting getting-off operation in a case where a passenger of a vehicle gets off the vehicle.

What is claimed is:

1. A getting-off support apparatus comprising:
a measurement unit configured to measure an approaching direction and moving velocity of a mobile object that approaches an own vehicle, and a distance between the own vehicle and the mobile object;
a getting-off operation detection unit configured to detect getting-off operation of a passenger in the own vehicle;
a notification signal output unit configured to output a notification signal for notifying at least one of the mobile object or the passenger of approach between the own vehicle and the mobile object; and
a control unit configured to, in a case where the getting-off operation is detected, control output of the notification signal in accordance with the distance and the moving velocity of the mobile object, wherein
the notification signal output unit includes a vehicle interior notification signal output unit configured to output a second notification signal for notifying the passenger of approach of the mobile object,
in a case where the getting-off operation is detected, the control unit estimates a period until when the mobile object reaches the own vehicle, from the distance and the moving velocity of the mobile object, and
in a case where, for the mobile object for which the estimated period is equal to or greater than a threshold set in advance, the distance is less than a limit distance set in advance, and the moving velocity is equal to or greater than limit velocity set in advance, the control unit outputs the second notification signal.

2. The getting-off support apparatus according to claim 1, wherein
the notification signal output unit includes a vehicle exterior notification signal output unit configured to output a first notification signal for notifying the mobile object of existence of the own vehicle, and
in a case where the getting-off operation is detected, the control unit controls output of the first notification signal in accordance with the distance and the moving velocity of the mobile object.

3. The getting-off support apparatus according to claim 2, wherein the control unit determines to output the first notification signal in a case where the estimated period is equal to or greater than a threshold set in advance and output the second notification signal along with the first notification signal in a case where the estimated period is less than the threshold.

4. The getting-off support apparatus according to claim 1, further comprising:
a door detection unit configured to detect a position and movement of a door of the own vehicle,
wherein the getting-off operation detection unit detects operation of the passenger in the own vehicle getting off from the door as the getting-off operation,
the notification signal output unit includes:
a right notification signal output unit configured to output a third notification signal as the notification signal for notifying the mobile object that approaches a right side of the own vehicle of existence of the own vehicle; and
a left notification signal output unit configured to output a fourth notification signal as the notification signal for notifying the mobile object that approaches a left side of the own vehicle of existence of the own vehicle, and
in a case where the getting-off operation is detected, and in a case where the position of the door from which the passenger gets off the own vehicle matches a side on which the mobile object approaches the own vehicle, the control unit controls output of the third notification signal or the fourth notification signal corresponding to the side.

5. The getting-off support apparatus according to claim 4, wherein
the door detection unit determines whether a type of the door for which the getting-off operation detection unit detects the getting-off operation is a swing door or a sliding door,
in a case where the getting-off operation is associated with the swing door, the control unit determines to output the notification signal in a case where the distance is less than a first distance, and
in a case where the getting-off operation is associated with the sliding door, the control unit determines to output the notification signal in a case where the distance is greater than the first distance and less than a second distance.

6. The getting-off support apparatus according to claim 4, wherein
the notification signal output unit further comprises a vehicle interior notification signal output unit configured to output a second notification signal for notifying the passenger of approach of the mobile object,
the door detection unit identifies whether a type of the door is a sliding door or a swing door, and
the control unit outputs the second notification signal after the notification signal in a case where the getting-off operation is associated with the swing door, and outputs the second notification signal before the notification signal or at the same time as the notification signal in a case where the getting-off operation is associated with the sliding door.

7. A getting-off support method comprising:
a measurement step of measuring an approaching direction and moving velocity of a mobile object that approaches an own vehicle, and a distance between the own vehicle and the mobile object;
a getting-off operation detection step of detecting getting-off operation of a passenger in the own vehicle;
a notification signal output step of outputting a notification signal for notifying at least one of the mobile object or the passenger of approach between the own vehicle and the mobile object; and
a control step of, in a case where the getting-off operation is detected, controlling output of the notification signal in accordance with the distance and the moving velocity of the mobile object, wherein
the notification signal output step includes a vehicle interior notification signal output step of outputting a second notification signal for notifying the passenger of approach of the mobile object,
the control step estimates, in a case where the getting-off operation is detected, a period until when the mobile object reaches the own vehicle, from the distance and the moving velocity of the mobile object, and
in a case where for the mobile object for which the estimated period is equal to or greater than a threshold set in advance, the distance is less than a limit distance set in advance, and the moving velocity is equal to or greater than limit velocity set in advance, the second notification signal is output.

8. A non-transitory computer-readable medium storing a program for causing a computer to execute a getting-off support method, the non-transitory computer-readable medium comprising:
a measurement step of measuring an approaching direction and moving velocity of a mobile object that approaches an own vehicle, and a distance between the own vehicle and the mobile object;
a getting-off operation detection step of detecting getting-off operation of a passenger in the own vehicle;
a notification signal output step of outputting a notification signal for notifying at least one of the mobile object or the passenger of approach between the own vehicle and the mobile object; and
a control step of controlling output of the notification signal in accordance with the distance and the moving velocity of the mobile object in a case where the getting-off operation is detected, wherein
the notification signal output step includes a vehicle interior notification signal output step of outputting a second notification signal for notifying the passenger of approach of the mobile object,
the control step estimates, in a case where the getting-off operation is detected, a period until when the mobile object reaches the own vehicle, from the distance and the moving velocity of the mobile object, and
in a case where for the mobile object for which the estimated period is equal to or greater than a threshold set in advance, the distance is less than a limit distance set in advance, and the moving velocity is equal to or greater than limit velocity set in advance, the second notification signal is output.
